(19) United States
(12) Patent Application Publication
(10) Pub. No.: US 2025/0247683 A1
(43) Pub. Date: Jul. 31, 2025

(54) OPTIMIZED CHANNEL SCANNING FOR AN ACCESS POINT DEVICE

(71) Applicant: Cypress Semiconductor Corporation, San Jose, CA (US)

(72) Inventors: Yashas Nanjungud Suryanarayana Iyer, Bangaluru (IN); Siddeshi Annapura Prakash, Bangalore (IN)

(73) Assignee: Cypress Semiconductor Corporation, San Jose, CA (US)

(21) Appl. No.: 18/424,231

(22) Filed: Jan. 26, 2024

(51) Int. Cl. H04W 8/00; H04W 48/18; H04W 72/0453; H04W 72/54

(52) U.S. Cl. CPC H04W 8/005; H04W 48/18; H04W 72/0453; H04W 72/54

(57) ABSTRACT

Methods and systems for optimized channel scanning for an access point device. The disclosed method includes, among other things, initializing, by a station device, an access point (AP) in a wireless network, selecting, by the station device, a preferred scanning channel (PSC) of a plurality of PSCs in a high frequency band of the wireless network, scanning, by the station device, the PSC of the plurality of PSCs, determining whether the PSC is free of wireless activity, and responsive to determining that the PSC is free of wireless activity, selecting the PSC for the AP to operate on.

### TECHNICAL FIELD

This disclosure relates to wireless devices and, more specifically, for optimized channel scanning for an access point device.

### BACKGROUND

Access point devices in wireless networks play a crucial role in enabling wireless communication between a variety of client devices, also known as stations. It serves as a vital bridge between these stations and a wired network, typically based on Ethernet.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 is a block diagram of an exemplary station device, in accordance with implementations of the present disclosure.

FIG. 2 is a simplified diagram of a frequency band, in accordance with implementations of the present disclosure.

FIG. 3 depicts a flow diagram of an example method for obtaining an operating channel for the access point, in accordance with implementations of the present disclosure.

FIG. 4 depicts a flow diagram of an example method for scanning the PSC of the frequency band for a PSC free of wireless activity, in accordance with implementations of the present disclosure.

FIG. 5 depicts a flow diagram of an example method for scanning another frequency band for unoccupied non-PSC of the frequency band, in accordance with implementations of the present disclosure.

### DETAILED DESCRIPTION

Aspects of the present disclosure relate to optimized channel scanning for an access point (AP) device or a wireless device (e.g., station device) operating as an access point (e.g., a software access point or SoftAP). AP device or SoftAP (herein collectively referred to as “AP”) facilitates wireless connectivity for client devices, such as laptops, smartphones, and tablets. During the initialization process of the AP, a comprehensive scan and assessment of all available channels within a given frequency band are conducted. This meticulous process aims to select the most optimal operating channel (or best channel), taking into consideration factors such as signal strength, channel usage, and the presence of other networks.

As wireless communication continues its expansion into higher frequency bands, particularly the 6 gigahertz (GHz) band, the traditional scanning process for selecting the operating channel has become notably more time-consuming. Notably, Institute of Electrical and Electronics Engineers (IEEE) 802.11ax (or 6E) introduces a wider channel spectrum, offering an impressive 59 available channels designated for communication. This stands in stark contrast to its predecessors, IEEE 802.11ac, which provides 24 available channels, and IEEE 802.11n, with a range of 11-24 available channels for communication. The increase in available channels corresponds to the broader spectrum of the frequency band, amplifying the complexity of evaluating each available channel.

However, the growing number of available channels correlates with the expansion of the frequency band, resulting in a more lengthy process for channel evaluation. This, in turn, can lead to delays as the AP dedicates additional time to complete the channel selection. Furthermore, the variability and irregularities in the timing of this process may introduce jitter. Although some of these delays have been shortened due to requiring preferred scanning channels (PSCs) in the 6 GHz frequency band (shortening the number of available channels to be scanned from 59 to 15), there are still significant delays. Collectively, these delays and jitter can adversely affect various Key Performance Indicators (KPIs) associated with the AP. KPIs serve as metrics employed to measure the effectiveness and efficiency of network operations, with a specific focus on evaluating the performance and efficiency of the AP's initialization process. The delays incurred during the channel selection process can extend the time required for the AP to achieve full operational status. This, in turn, can impact KPIs related to timing and efficiency, ultimately affecting the overall performance of the network.

Aspects and embodiments of the present disclosure address these and other limitations of the existing technology by performing an optimized channel scanning for the access point device. More specifically, rather than scanning all channels or PSCs of the 6 GHz frequency band (e.g., a high frequency band), each PSC of the high frequency band is individually scanned and assessed to determine whether the PSC is free of wireless activity. The PSC is free of wireless activity if there are no ongoing transmissions. Once a PSC of the high frequency band is identified to be free of wireless activity, the respective PSC is selected as an operating channel for the AP to transmit and receive data from client devices.

If each PSC of the high frequency band is determined to not be free of wireless activity, a lower frequency band (e.g., 2.4 GHz frequency band and/or 5 Ghz frequency band) is scanned and assessed. More specifically, all channels of the lower frequency band are scanned and assessed. Typically, the channels of the lower frequency band may include other APs broadcasting beaconing frames on channels of the lower frequency band. The broadcasted beaconing frames may include reduced neighbor report (RNR) information, which refers to a data packet used to convey information about neighboring APs and other wireless devices. Thus, the RNR information channels may indicate channels in the high frequency band occupied by the other APs that are beaconing on channels of the lower frequency band. Accordingly, a subset of channels in the high frequency band may be determined by excluding the PSCs and the channels in the high frequency indicated in the broadcasted beaconing frames. If at least one channel is present in the subset of channels in the high frequency band, a channel may be selected from the subset of channels in the high frequency band as an operating channel for the AP to transmit and receive data from client devices.

If no channels are present in the subset of channels in the high frequency band, the PSCs in the high frequency are assessed for channel utilization information. In particular, since each PSC was scanned and assessed to determine whether they are free of wireless activity, information from the original scan and assessment, which included channel utilization information may be used to determine a PSC in the high frequency band with the least congestion. Channel utilization information provides metrics, typically represented as a percentage or numerical value, indicating the number of client devices connected to an AP, the amount of traffic, and/or the amount of interference. Accordingly, the PSC in the high frequency band with the least congestion is determined by comparing the channel utilization information of all PSCs in the high frequency band to one another to determine which PSC has the lowest channel utilization information. The PSC in the high frequency band with the least congestion is selected as an operating channel for the AP to transmit and receive data from client devices.

Aspects of the present disclosure overcome these deficiencies and others by avoiding performing scans of all channels in the high frequency band (e.g., 6 GHz frequency band) to select the best channel, reducing the overall delay time, increasing the KPIs associated with the AP related to timing and efficiency, ultimately increasing the overall performance of the network.

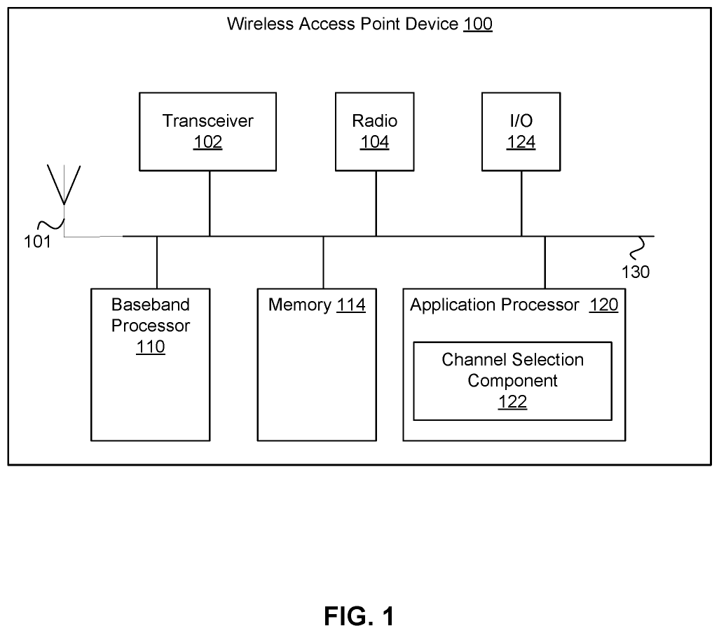

FIG. 1 is a block diagram of an exemplary station device (or wireless device) 100, in accordance with implementations of the present disclosure. In at least some embodiments, station device 100 includes, but is not limited to, a transmitter 102 (e.g., a PAN transmitter), a receiver 104 (e.g., a PAN receiver), a communications interface 106, a transmitter (TX) antenna 112 coupled to the transmitter 102, a receiver (RX) antenna 114 coupled to the receiver 104, a memory 116, one or more input/output (I/O) devices 118 (such as a display screen, a touch screen, a keypad, and the like), and a processor 120. These components can all be coupled to a communications bus 130. In some embodiments, aspects of the communication interface 106 work with the processor 120 to perform operations or functions as a processing device of the station device 100. In some embodiments, there is a single antenna and multiplexing logic to switch the use of the antenna between the transmitter 102 and receiver 104. In various embodiments, front end components such as the transmitter 102, the receiver 104, the communication interface 106, and the one or more antennas (e.g., TX antenna 112 and/or RX antenna 114) described herein within various devices are adapted with or configured for WLAN and PAN-based frequency bands, e.g., Bluetooth® (BT), BLE, Wi-Fi™, Zigbee®, Z-wave™, and the like.

Processor 120 may execute software and/or firmware to enable station device 100 to share its network connection with other station devices (i.e., the station device 100 is configured to operate as a wireless access point (e.g., a software access point or SoftAP)).

Processor 120 may further include a channel selection component 122. In response to initializing the Station device 100 to operate on a high frequency band (e.g., 6 Ghz frequency band), channel selection component 122 selects a preferred scanning channel (PSC) in the high frequency band of a wireless network. Preferred scanning channel (PSC) refers to one or more channels in a frequency band that is given preference or priority during the scanning to discover and evaluate available wireless networks in their vicinity. PSCs optimize scanning efficiency by focusing on the one or more channels rather than scanning all channels in the frequency band to reduce the time and resources required for the scanning. In some embodiments, the PSC is selected sequentially, or randomly. Channel selection component 122 scans the PSC. After scanning a PSC of the high frequency band, channel selection component 122 assesses the PSC to determine whether the respective PSC is free of wireless activity. Depending on the embodiment, the PSC is determined to be free of wireless activity if there is no ongoing wireless transmission on the PSC by neighboring APs or other wireless devices on the respective PSC. If the PSC is determined to be free of wireless activity, channel selection component 122 selects the PSC as the operating channel for the AP (or the channel for the AP to operate on). Once the PSC is selected as the operating channel, channel selection component 122 does not proceed further with scanning additional PSCs in the high frequency band. If the PSC is determined to not be free of wireless activity, channel selection component 122 scans and assess another PSC in the high frequency band to identify a PSC in the high frequency band free of wireless activity.

In some embodiments, all PSCs in the high frequency band are scanned and assessed without identifying a PSC free of wireless activity (i.e., each PSC in the high frequency is not free of wireless activity). As a result, channel selection component 122 causes the AP to switch from a high frequency to a lower frequency. For example, in a tri-band implementation, the AP switches the radio from 6 GHz to 2.4/5 GHz. Channel selection component 122 scans the lower frequency band (e.g., all channels in the lower frequency band). Lower frequency band may be a 2.4 GHz frequency band and/or a 5 Ghz frequency band. Once all channels of the lower frequency band are scanned, channel selection component 122 assesses the scanned channels of the lower frequency band for reduced neighbor report (RNR) information. RNR information is typically included in either beacon or probe response frames broadcasted in channels of the 2.4 GHz frequency band and/or 5 GHz frequency band by neighboring APs. RNR information refers to a data packet used to convey information about neighboring APs and other wireless devices. In some embodiments, the RNR information may provide information regarding what channel in the high frequency band the neighboring APs are occupying. For example, Station device 100 switches from 6 GHz to 5 GHz. AP scans all channels of the 5 GHz frequency band to obtain RNR information. Each neighboring AP operating in 6 GHz beacons in 5 GHz with information indicating which channel in 6 GHz it is occupying. Station device 100 may analyze and extract information indicating a channel in 6 GHz being occupied.

Based on the RNR information, channel selection component 122 may identify one or more channels other than PSCs, also referred to as non-PSCs, in the high frequency band occupied by neighboring APs (e.g., a occupied non-PSCs). Based on the occupied non-PSCs, channel selection component 122 may identify a unoccupied non-PSCs in the high frequency band. In other words, channel selection component 122 removes from the non-PSCs in the high frequency band the occupied non-PSCs to obtain the unoccupied non-PSCs. The obtained unoccupied non-PSCs represents a sequential list of non-PSCs that are unoccupied by neighboring APs. Channel selection component 122 may select a non-PSC of the unoccupied non-PSCs as the operating channel for the AP. In some embodiments, channel selection component 122 may select a predetermined non-PSC of the unoccupied non-PSCs (e.g., a first unoccupied non-PSC of the unoccupied non-PSCs) as the operating channel for the AP. In some embodiments, channel selection component 122 may randomly select a non-PSC of the unoccupied non-PSCs as the operating channel for the AP.

In some embodiments, channel selection component 122 may not, based on the RNR information, identify a unoccupied non-PSCs in the high frequency band indicating that all non-PSCs in the high frequency band are occupied. In response, channel selection component 122 identifies a PSC in the high frequency band that is the least congested. In particular, channel selection component 122 obtains channel utilization information for each PSC in the high frequency band. Channel utilization information provides metrics, typically represented as a percentage or numerical value, indicating the number of client devices connected to an AP, the amount of traffic, and/or the amount of interference. Channel selection component 122 selects, based on the channel utilization information for all PSCs in the high frequency band, the PSC with the least congestion as the operating channel. The PSC with the least congestion is determined by comparing the channel utilization information of all PSCs in the high frequency band to one another to determine which PSC has the lowest channel utilization information.

Depending on the embodiment, channel selection component 122 may identify a non-PSC in the high frequency band that is the least congested. In particular, channel selection component 122 obtains channel utilization information for each non-PSC in the high frequency band. Channel selection component 122 selects, based on the channel utilization information for all non-PSCs in the high frequency band, the non-PSC with the least congestion as the operating channel. The non-PSC with the least congestion is determined by comparing the channel utilization information of all non-PSCs in the high frequency band to one another to determine which non-PSC has the lowest channel utilization information.

Depending on the embodiment, channel selection component 122 may identify a channel in the high frequency band that is the least congested. In particular, channel selection component 122 obtains channel utilization information for all channels in the high frequency band (e.g., both PSCs and non-PSCs). Channel selection component 122 selects, based on the channel utilization information for all channels in the high frequency band, the channel with the least congestion as the operating channel. The channel with the least congestion is determined by comparing the channel utilization information of all channels in the high frequency band to one another to determine which channel has the lowest channel utilization information.

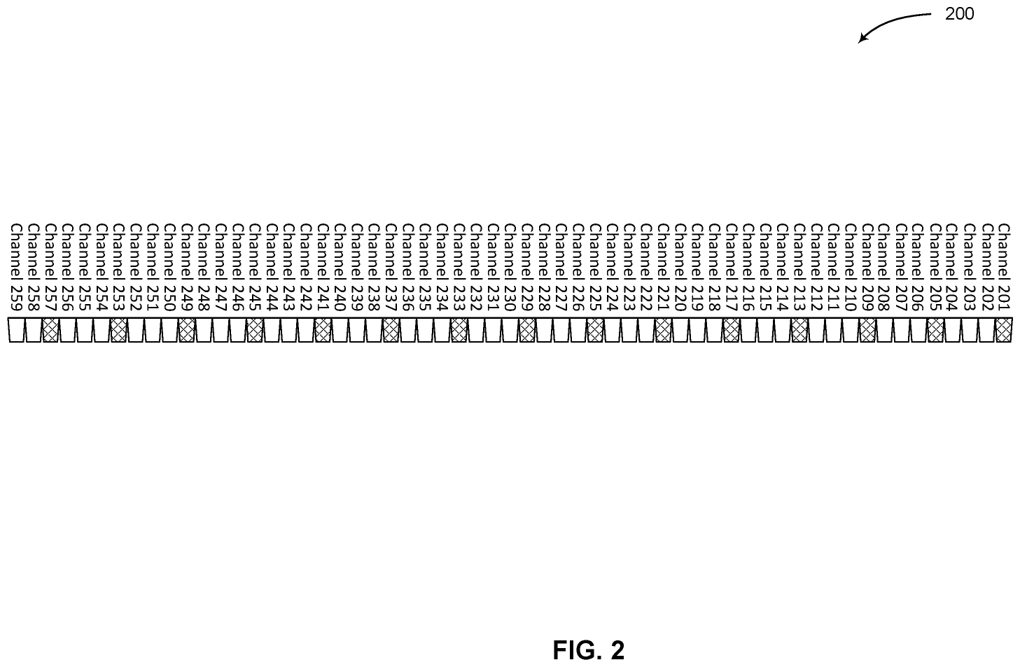

FIG. 2 is a simplified diagram of a frequency band 200, in accordance with implementations of the present disclosure. Frequency band 200 is similar to the high frequency band. In particular, frequency band 200 is a 6 GHz frequency band including 59 channels (e.g., channel 201 to channel 259). Channels 201, 205, 209, 213, 217, 221, 225, 229, 233, 237, 241, 245, 249, 253, and 257 refer to the PSCs of frequency band 200. The remaining channels are referred to as non-PSCs (e.g., channels 202-204, channels 206-208, channels 210-212, channels 214-216, channels 218-220, channels 222-224, channels 226-228, channels 230-232, 234-236, channels 238-240, channels 242-244, channels 246-248, channels 250-252, channels 254-256, and channels 258-259).

Accordingly, as channel selection component 122 of FIG. 1 sequentially scans the PSCs in frequency band 200, channel selection component 122 scans and assesses channel 201. If channel 201 is free of wireless activity, then channel selection component 122 selects channel 201 as the operating channel. Otherwise, channel selection component 122 scans and assesses channel 205. If channel 205 is free of wireless activity, then channel selection component 122 selects channel 205 as the operating channel. Otherwise, channel selection component 122 scans and assesses channel 209. If channel 209 is free of wireless activity, then channel selection component 122 selects channel 209 as the operating channel. Otherwise, channel selection component 122 scans and assesses each subsequent channel (i.e., channel 213, then channel 217, and so on) until a channel free of wireless activity is identified or all channels are scanned and assessed.

Additionally, in response to the channel selection component 122 scanning all channels of a lower frequency band (e.g., 2.4 GHz and/or 5 GHz frequency band), the RNR information obtained by the channel selection component 122 is used to identify a subset of channels in frequency band 200 not occupied by neighboring APs. In particular, the subset of channels in the frequency band 200 includes all channels in the frequency band 200 excluding PSCs (e.g., channels 201, 205, 209, 213, 217, 221, 225, 229, 233, 237, 241, 245, 249, 253, and 257) and occupied non-PSCs (i.e., those indicated in RNR information included in either beacon or probe response frames by neighboring APs).

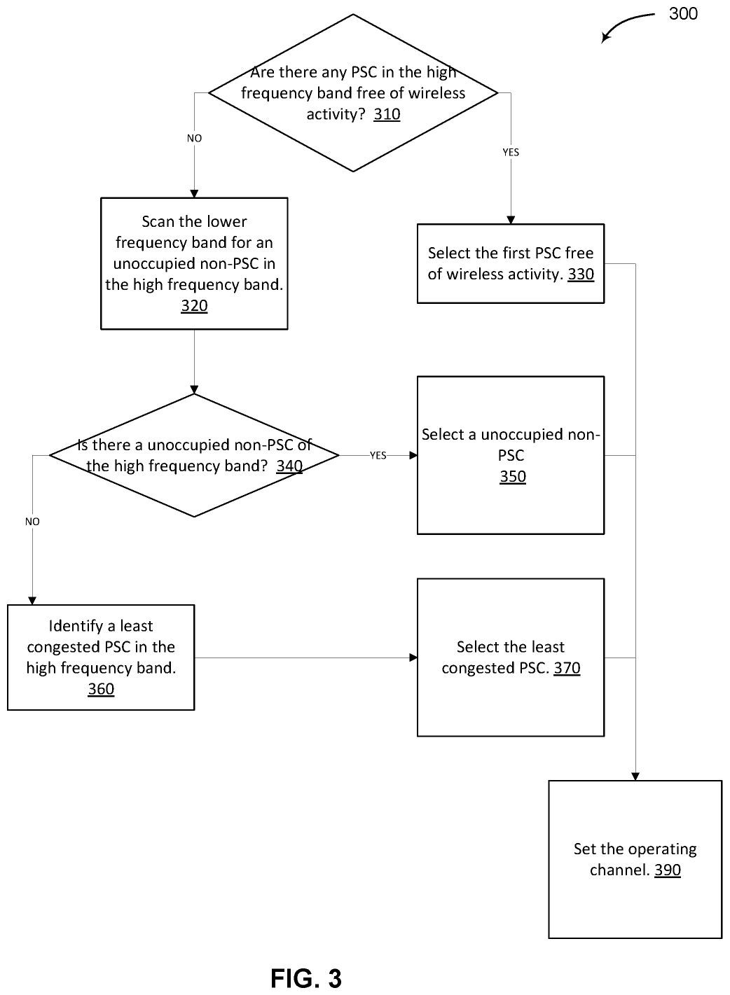

FIG. 3 is a flow diagram of a method 300 of obtaining an operating channel for the AP, in accordance with implementations of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by the Station device 100, including the channel selection component 122 and/or the application processor 120 (e.g., processing device).

At operation 310, the processing logic determines whether any preferred scanning channel (PSC) in the high frequency band (e.g., 6 Ghz frequency) is free of wireless activity. As previously described, a PSC in the high frequency band is selected either sequentially or randomly. Once selected, the PSC is scanned and assessed to determine whether the PSC is free of wireless activity. Free of wireless activity refers to no ongoing wireless transmission by neighboring APs or other wireless devices. Once the PSC is determined to be free of wireless activity, at operation 330, the processing logic selects the PSC as the operating channel for the AP. Once the PSC is selected as the operating channel for the AP, the processing logic does not proceed with selecting additional PSCs to be scanned and assessed.

If all the PSC are scanned and assessed not to be free of wireless activity, at operation 320, the processing logic scans the lower frequency band (e.g., 2.4 Ghz and/or 5 Ghz frequency band) for an unoccupied non-PSC in the high frequency band by switching the AP from the high frequency to the lower frequency. As previously described, all channels of the lower frequency band are scanned. The scanned channels of the lower frequency are assessed for RNR information. The RNR information includes information regarding what channel in the high frequency band each neighboring AP is occupying. For example, AP uses the obtained RNR information from the lower frequency band to obtain information about other APs operating and occupying a channel in higher frequency band. Thus, from the RNR information obtained from the lower frequency band, occupied non-PSCs in the high frequency band may be determined.

At operation 340, the processing logic determines whether there is an unoccupied non-PSC in the high frequency band. In particular, unoccupied non-PSCs of the high frequency band may be determined by removing the occupied non-PSCs from all non-PSCs of the high frequency band. Thus, if there is at least one unoccupied non-PSC of the high frequency range then, at operation 350, the processing logic selects an unoccupied non-PSC. As previously described, the first unoccupied non-PSC is selected, or the unoccupied non-PSC is selected randomly.

If there is not at least one unoccupied non-PSC of the high frequency range then, at operation 360, the processing logic identifies the least congested PSC (or non-PSC) in the high frequency band. As previously described, since there was no PSC in the high frequency free of wireless activity, each PSC in the high frequency band was scanned and assessed. Thus, channel utilization information may be obtained for each PSC. Channel utilization information provides metrics, typically represented as a percentage or numerical value, indicating how much time the channel is actively used for transmitting data. The PSC with the least congestion is determined by comparing the channel utilization information of all PSCs in the high frequency band to one another to determine which PSC has the lowest channel utilization information. Once the PSC with the lowest channel utilization information, also referred to as the least congested PSC (or non-PSC), is determined, at operation 370, the processing logic selects the least congested PSC (or non-PSC).

At operation 380, the processing logic sets the operating channel (i.e., sets the AP to operate on the operating channel). The operating channel is set with the PSC free of wireless activity, the unoccupied non-PSC, or the least congested PSC (or non-PSC). In particular, if the PSC free of wireless activity was selected, then it is used to set the operating channel for the AP. If the unoccupied non-PSC was selected then it is used to set the operating channel for the AP, or if the least congested PSC (or non-PSC) was selected then it is used to set the operating channel for the AP.

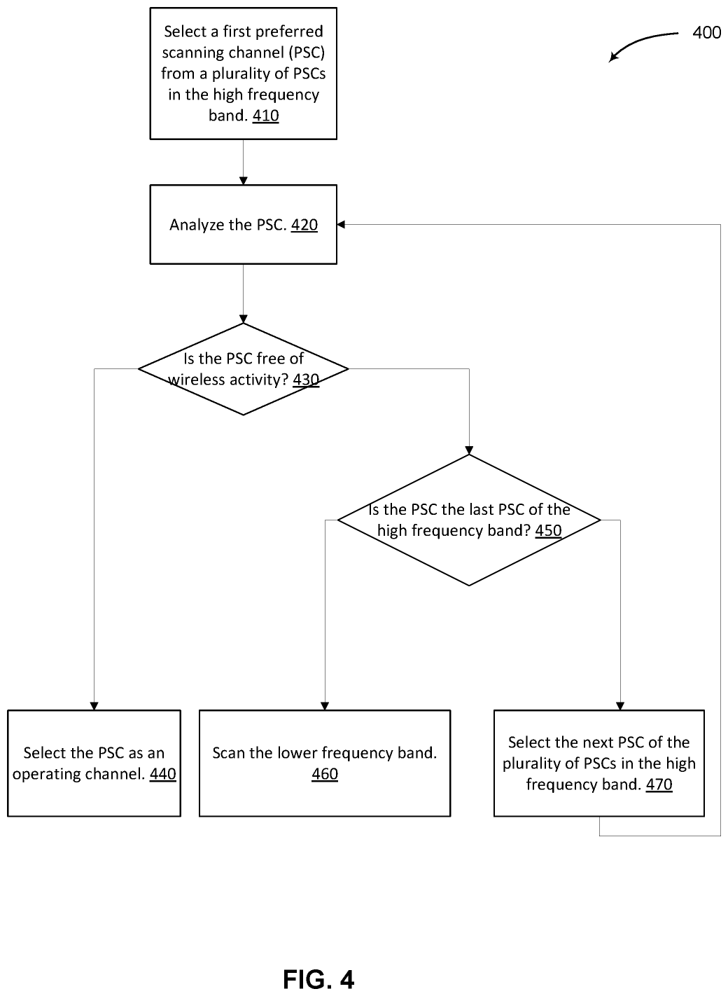

FIG. 4 is a flow diagram of a method 400 of scanning the PSC of the frequency band for a PSC free of wireless activity, in accordance with implementations of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the Station device 100, including the channel selection component 122 and/or the application processor 120 (e.g., processing device).

At operation 410, the processing logic selects a first preferred scanning channel (PSC) from a plurality of PSCs in the high frequency band (e.g., 6 Ghz frequency band). As previously described, PSC refers to a subset of channels in the high frequency band that is given preference or priority during the scanning to discover and evaluate available wireless networks in their vicinity. The plurality of PSCs optimizes scanning efficiency by focusing on the subset of channels rather than scanning all available channels in the frequency band to reduce the time and resources required for the scanning.

At operation 420, the processing logic analyzes the PSC in the high frequency band and, at operation 430, determines whether the PSC is free of wireless activity. Free of wireless activity refers to no ongoing wireless transmission by neighboring APs or other wireless devices. Once the PSC is assessed to be free of wireless activity, at operation 440, the processing logic selects the PSC as an operating channel.

At operation 450, if the PSC is assessed and determined to include wireless activity, the processing logic determines whether the PSC is the last PSC in the high frequency band. If the PSC is not the last PSC in the high frequency band, at operation 470, the processing logic selects the next PSC of the plurality of PSCs in the high frequency and proceeds to operation 420. If the PSC is the last PSC in the 6 Ghz frequency band, at operation 460, the processing logic scans the lower frequency band (e.g., the 2.4 Ghz frequency band and/or the 5 Ghz frequency band).

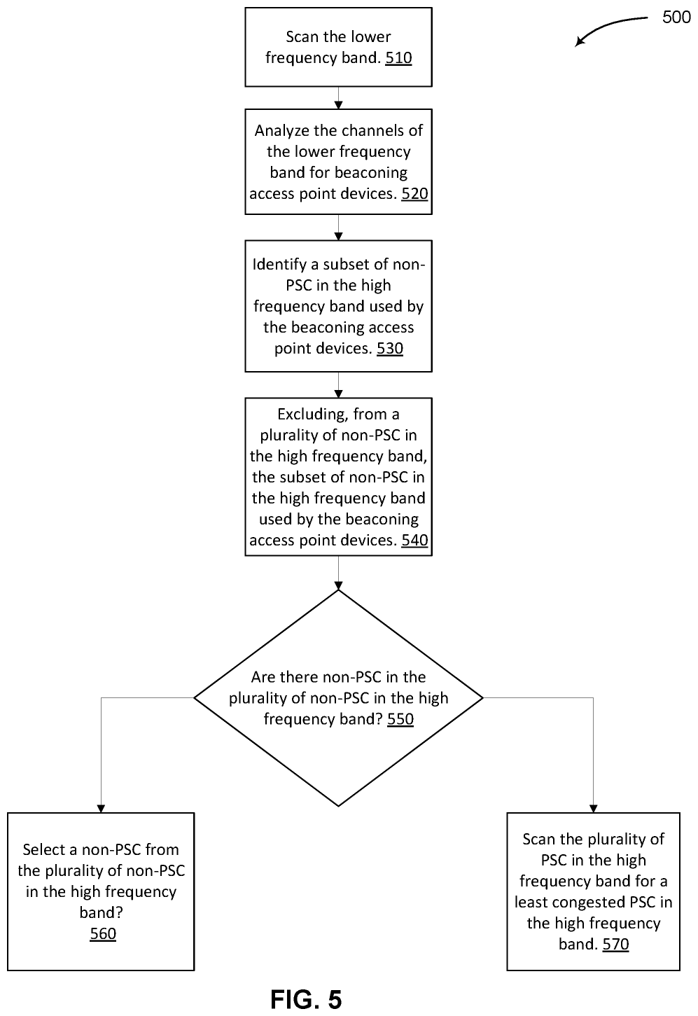

FIG. 5 is a flow diagram of a method 500 of scanning another frequency band for unoccupied non-PSC of the frequency band, in accordance with implementations of the present disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by the Station device 100, including the channel selection component 122 and/or the application processor 120 (e.g., processing device).

At operation 510, the processing logic scans the lower frequency band (e.g., 5 Ghz frequency band and/or the 2.4 frequency band). As previously described, scanning the lower frequency band includes scanning all channels of the 5 GHz and/or 2.4 GHz frequency band.

At operation 520, the processing logic analyzes the scanned channels of the lower frequency band for beaconing access point devices. As previously described, all channels of the lower frequency band are scanned. The scanned channels of the lower frequency are assessed for RNR information. The RNR information includes information regarding what channel in the high frequency band each neighboring AP is occupying. For example, AP uses the obtained RNR information from the lower frequency band to obtain information about other APs operating and occupying a channel in higher frequency band. Thus, from the RNR information obtained from the lower frequency band, occupied non-PSCs in the high frequency band may be determined.

Accordingly, at operation 530, the processing logic identifies a subset of non-PSCs from a plurality of non-PSCs in the high frequency band used by the beaconing access point devices. The subset of non-PSCs may be referred to as a occupied non-PSCs. As previously described, the occupied non-PSCs is identified using the RNR information associated with the beaconing APs. At operation 540, the processing logic excludes from the occupied non-PSCs from the plurality of non-PSC in the 6 Ghz frequency band to generate a unoccupied non-PSCs.

At operation 550, the processing logic determines whether there are non-PSC in the occupied non-PSCs in the 6 Ghz frequency band. If there is at least one unoccupied non-PSC in the occupied non-PSCs, at operation 560, the processing logic selects a non-PSC from the occupied non-PSCs in the 6 Ghz frequency band as the operating channel for the AP. Otherwise, if there is no unoccupied non-PSC in the occupied non-PSCs, at operation 570, the processing logic scans the plurality of PSCs in the 6 Ghz frequency band (e.g., high frequency band) for the least congested PSC (or non-PSC). As previously described, to scan the plurality of PSCs (and/or plurality of non-PSCs) in the high frequency band for the least congested PSC (or non-PSC), channel utilization information (e.g., metrics indicating how much time the channel is actively used for transmitting data) is obtained for each PSC in the high frequency band (and/or each non-PSC in the high frequency band). The channel utilization information of all PSCs (and/or non-PSCs) in the high frequency band is compared to one another to determine which PSC (and/or non-PSC) has the lowest channel utilization information indicating the least congested PSC (or non-PSC).

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, refer to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer-readable medium; or a combination thereof.

The aforementioned systems, circuits, modules, and so on have been described with respect to interaction between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include a collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
initializing, by a station device, an access point (AP) in a wireless network;
selecting, by the station device, a preferred scanning channel (PSC) of a plurality of PSCs in a high frequency band of the wireless network
scanning, by the station device, the PSC of the plurality of PSCs;
determining whether the PSC is free of wireless activity; and
responsive to determining that the PSC is free of wireless activity, selecting the PSC for the AP to operate on.

2. The method of claim 1, wherein determining that the PSC is free of wireless activity includes determining that there are no ongoing wireless transmissions by neighboring APs or any other wireless devices.

3. The method of claim 1, further comprising:
responsive to determining that each PSC of the plurality of PSCs is not free of wireless activity, scanning, by the station device, all channels in a lower frequency band of the wireless network;
identifying, based on the scanning, an unoccupied non-PSC of a plurality of non-PSCs; and
selecting the unoccupied non-PSC for the AP to operate on.

4. The method of claim 3, wherein identifying, based on the scanning, the unoccupied non-PSC of the plurality of non-PSCs comprises:
identifying one or more beaconing frames broadcasted in the lower frequency band, wherein each non-PSC identified in the one or more beaconing frames broadcasted in the lower frequency band is included in a occupied non-PSCs;
removing, from the plurality of non-PSCs, the occupied non-PSCs to generate a unoccupied non-PSCs; and
selecting, from the unoccupied non-PSCs, the unoccupied non-PSC.

5. The method of claim 4, wherein the unoccupied non-PSC is randomly selected from the unoccupied non-PSCs.

6. The method of claim 3, wherein the high frequency band of the wireless network is a 6 GHz frequency band, and the lower frequency band of the wireless network is one of a 2.4 GHz or 5 GHz frequency band.

7. The method of claim 1, further comprising:
responsive to determining that all non-PSCs of the non-PSCs are occupied, identifying, from the plurality of PSCs, a least congested PSC; and
selecting the least congested PSC for the AP to operate on.

8. The method of claim 7, wherein identifying, from the plurality of PSCs, the least congested PSC comprises:
obtaining, from information associated with the scanning of the plurality of PSCs, channel utilization for each PSC of the plurality of PSCs; and
comparing the channel utilization of the plurality of PSCs with one another to identify the PSC having a lowest channel utilization as the least congested PSC.

9. A station device, comprising:
a processor, wherein the processor is to perform operations comprising:
responsive to initializing, by the station device, an access point (AP) in a wireless network;
selecting, by the station device, a preferred scanning channel (PSC) of a plurality of PSCs in a high frequency band of the wireless network
scanning, by the station device, the PSC of the plurality of PSCs;
determining whether the PSC is free of wireless activity; and
responsive to determining that the PSC is free of wireless activity, selecting the PSC for the AP to operate on.

10. The station device of claim 9, wherein determining that the PSC is free of wireless activity includes determining that there are no ongoing wireless transmissions by neighboring APs or any other wireless devices.

11. The station device of claim 9, wherein the processor is to perform operations further comprising:
responsive to determining that each PSC of the plurality of PSCs is not free of wireless activity, scanning, by the station device, all channels in a lower frequency band of the wireless network;
identifying, based on the scanning, an unoccupied non-PSC of a plurality of non-PSCs; and
selecting the unoccupied non-PSC for the AP to operate on.

12. The station device of claim 11, wherein identifying, based on the scanning, the unoccupied non-PSC of the plurality of non-PSCs comprises:
identifying one or more beaconing frames broadcasted in the lower frequency band, wherein each non-PSC identified in the one or more beaconing frames broadcasted in the lower frequency band is included in a occupied non-PSCs;
removing, from the plurality of non-PSCs, the occupied non-PSCs to generate a unoccupied non-PSCs; and
selecting, from the unoccupied non-PSCs, the unoccupied non-PSC.

13. The station device of claim 12, wherein the unoccupied non-PSC is randomly selected from the unoccupied non-PSCs.

14. The station device of claim 11, wherein the high frequency band of the wireless network is a 6 GHz frequency band, and the lower frequency band of the wireless network is one of a 2.4 GHz or 5 GHz frequency band.

15. The station device of claim 9, wherein the processor is to perform operations further comprising:
responsive to determining that all non-PSCs of the non-PSCs are occupied, identifying, from the plurality of PSCs, a least congested PSC; and
selecting the least congested PSC for the AP to operate on.

16. The station device of claim 15, wherein identifying, from the plurality of PSCs, the least congested PSC comprises:
obtaining, from information associated with the scanning of the plurality of PSCs, channel utilization for each PSC of the plurality of PSCs; and
comparing the channel utilization of the plurality of PSCs with one another to identify the PSC having a lowest channel utilization as the least congested PSC.

17. A wireless network comprising:
a plurality of wireless devices, wherein a wireless device of the plurality of wireless device is configured to operate as an access point (AP), and wherein a processor of the wireless device configured to operate as the AP is to perform operations comprising:
initializing the AP in the wireless network;
scanning, by the AP, a plurality of preferred scanning channels (PSCs) in a high frequency band of the wireless network for a PSC free of wireless activity;
responsive to determining that the plurality of PSCs is not free of wireless activity, scanning a lower frequency band of the wireless network for an unoccupied non-PSC;
responsive to determining that a plurality of non-PSCs are occupied, identifying a least congested PSC of the plurality of PSCs; and
selecting at least one of: the PSC free of wireless activity, the unoccupied non-PSC, or the least congested PSC for the AP to operate on.

18. The wireless network of claim 17, wherein scanning the plurality of PSCs in the high frequency band of the wireless network for the PSC free of wireless activity comprises:
sequentially scanning each PSC of the plurality of PSCs;
determining, during scanning of a respective PSC, whether the respective PSC is free of wireless activity, wherein the respective PSC is free of wireless activity when there are no ongoing transmissions by neighboring APs or any other wireless devices; and
responsive to determining that the respective PSC is free of wireless activity, selecting the respective PSC as the PSC free of wireless activity.

19. The wireless network of claim 17, wherein scanning the lower frequency band for the unoccupied non-PSC comprises:
identifying one or more beaconing frames broadcasted in channels in the lower frequency band, wherein each non-PSC identified in the one or more beaconing frames broadcasted in the lower frequency band is included in a occupied non-PSCs;
removing, from the plurality of non-PSCs, the occupied non-PSCs to generate a unoccupied non-PSCs; and
randomly selecting, from the unoccupied non-PSCs, an unoccupied non-PSC as the unoccupied non-PSC.

20. The wireless network of claim 17, wherein identifying the least congested PSC of the plurality of PSCs comprises:
obtaining, from information associated with the scanning of the plurality of PSCs, channel utilization for each PSC of the plurality of PSCs;
comparing the channel utilization of the plurality of PSCs with one another to identify the PSC having a lowest channel utilization; and
selecting the PSC having a lowest channel utilization as the least congested PSC.
